(19) United States
(12) Patent Application Publication
(10) Pub. No.: US 2025/0300792 A1
(43) Pub. Date: Sep. 25, 2025

(54) STATE-BASED SENSING SIGNAL CONFIGURATION AND TRANSMISSION

(71) Applicant: Huawei Technologies Co., Ltd., Shenzhen (CN)

(72) Inventors: Shahram Shahsavari, Ottawa (CA); Ahmed Wagdy Abdelwahab Shaban, Kanata (CA); Alireza Bayesteh, Brossard (CA)

(21) Appl. No.: 19/229,517

(22) Filed: Jun. 5, 2025

Related U.S. Application Data
(63) Continuation of application No. PCT/CN2022/136784, filed on Dec. 6, 2022.

(51) Int. Cl. H04L 5/00

(52) U.S. Cl. CPC H04L 5/0091

(57) ABSTRACT

Aspects of the present application relate to a state-based sensing signal design. Aspects of the present application also relate to employing the state-based sensing signal design in the context of an integrated communication and sensing system. Using the state-based sensing signal design, a sensing state of a sensing transmitting node may be embedded in the sensing signal. At a sensing receiving node, a received sensing signal may be processed to extract the embedded sensing state of the sensing transmitting node.

### CROSS REFERENCE

The present application is a continuation of International Application No. PCT/CN2022/136784, filed on Dec. 6, 2022, the disclosure of which is hereby incorporated by reference in its entirety.

### TECHNICAL FIELD

The present disclosure relates, generally, to sensing signal configuration, sensing signal transmission and, in particular embodiments, to basing such sensing signal configuration and transmission on a state of a device.

### BACKGROUND

For sensing applications in known wireless communication systems, sensing signals may be configured to indicate an identifier of a node transmitting the sensing signal (called the “sensing TX node” herein). This may be called an ID-based sensing signal design. A node receiving the sensing signal (called the “sensing RX node” herein) may obtain measurements of the received sensing signal and provide, to a network entity, an indication of the measurements along with an indication of the identity associated with the sensing TX node. Responsively, the network entity may be able to determine information regarding a state (e.g., position, velocity, orientation) of the sensing RX node. The network entity may subsequently provide, to the sensing RX node, an indication of the determined state of the sensing RX node.

### SUMMARY

Aspects of the present application relate to a state-based sensing signal design. Aspects of the present application also relate to employing the state-based sensing signal design in the context of an integrated communication and sensing system. Using the state-based sensing signal design, a sensing state of the sensing TX node may be embedded in the sensing signal. At the sensing RX node, a received sensing signal may be processed to extract the embedded sensing state of the sensing TX node. The sensing state of the sensing TX node may be used by the sensing RX node, in combination with other information, to allow the sensing RX node to determine its own sensing state.

The ID-based sensing signal design has been criticized for inherent complexity and latency associated with the need for information exchange between sensing RX node and the network entity. The ID-based sensing signal design has also been criticized for unsuitability to dynamic sensing scenarios, where the states (position, velocity or orientation) of anchors (reference points) are changing with time.

In contrast, the state-based sensing signal design representative of aspects of the present application may be shown to provide reduced complexity and reduced latency relative to the ID-based sensing signal design. These benefits may be shown to stem from a reduction of information exchange between the sensing RX node and the network entity. Conveniently, the sensing RX node may be empowered, by aspects of the present application, to directly estimate its own sensing state, based on measurements of a received sensing signal and without the help of a network entity. This, in turn, may be shown to reduce latency and power consumption, both of which may be shown to be important factors in future sensing applications.

According to an aspect of the present disclosure, there is provided a method for transmitting a sensing signal at a sensing signal transmitting node. The method includes obtaining, at the sensing signal transmitting node, a sensing state, determining, at the sensing signal transmitting node and based on the sensing state, a sensing signal parameter, generating, at the sensing signal transmitting node and based, at least in part, on the sensing signal parameter, the sensing signal and transmitting, at the sensing signal transmitting node, the sensing signal.

According to an aspect of the present disclosure, there is provided a method of configuring a network. The method includes defining a grid on a space including a plurality of sensing states for a first node, establishing a mapping between an area on the grid and a sensing signal parameter and transmitting, to a second node, an indication of the mapping.

Notably, the terms “grid” and “space” do not necessarily relate to a physical “grid” (as in, for example, a position-based grid definition) or a physical space. The terms “grid” and “space” may relate to a logical grid and a logical space, for example, in the case of a Doppler-based grid definition.

According to an aspect of the present disclosure, there is provided a method for sensing state self-determination at a sensing signal receiving node. The method includes receiving, at the sensing signal receiving node, a sensing signal, performing measurements on the sensing signal, processing the measurements to obtain a sensing signal parameter, obtaining, based on the sensing signal parameter, a sensing state for a sensing signal transmitting node at the origin of the sensing signal and obtaining, based on the sensing state for the sensing signal transmitting node, a sensing state for the sensing signal receiving node.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a region of interest, a position space, divided into an M by N position grid, in accordance with aspects of the present application;

FIG. 7 illustrates example steps in a method of configuring a network, in accordance with aspects of the present application;

FIG. 8 illustrates example steps in a method for transmitting a state-based sensing signal at a sensing signal transmitting node, wherein the state is a position in the grid of FIG. 6, in accordance with aspects of the present application;

FIG. 9 illustrates example steps in a method for sensing state self-determination at a sensing signal receiving node, wherein the state is a position in the grid of FIG. 6, in accordance with aspects of the present application;

FIG. 10 illustrates a velocity vector space divided into an M by N position grid, in accordance with aspects of the present application;

FIG. 11 illustrates example steps in a method for transmitting a state-based sensing signal at a sensing signal transmitting node, wherein the state is a velocity vector in the grid of FIG. 10, in accordance with aspects of the present application;

FIG. 12 illustrates example steps in a method for sensing state self-determination at a sensing signal receiving node, wherein the state is a velocity vector in the grid of FIG. 10, in accordance with aspects of the present application;

FIG. 13 illustrates a sensing TX node and a sensing RX node to provide contest for a review of the various terms used in a doppler shift formula;

FIG. 14 illustrates an angular space divided into an angular grid, in accordance with aspects of the present application;

FIG. 15 illustrates example steps in a method for transmitting a state-based sensing signal at a sensing signal transmitting node, wherein the state is a range of angles in the grid of FIG. 14, in accordance with aspects of the present application;

FIG. 16 illustrates example steps in a method for sensing state self-determination at a sensing signal receiving node, wherein the state is a range of angles in the grid of FIG. 14, in accordance with aspects of the present application;

FIG. 17 illustrates a device in a context formed by a base Cartesian coordinate system with three axes;

FIG. 18 illustrates a transmit receive point, a sensing transmitting node and a sensing receiving node, to provide context for a state of a device being an orientation;

FIG. 19 illustrates example steps in a method for transmitting a state-based sensing signal at a sensing signal transmitting node, wherein the state is an orientation in the context of FIG. 18, in accordance with aspects of the present application;

FIG. 20 illustrates example steps in a method for sensing state self-determination at a sensing signal receiving node, the state is an orientation in the context of FIG. 18, in accordance with aspects of the present application;

FIG. 21 illustrates an M by N two-dimensional grid as an example of a digital-based constellation design, in accordance with aspects of the present application;

FIG. 22 illustrates, in a signal flow diagram, interaction between a sensing transmitting node, an SMF and a sensing receiving node, in accordance with aspects of the present application;

FIG. 23 illustrates an example network area that has been covered by repeating a smaller, two-dimensional grid four times, in accordance with aspects of the present application;

FIG. 24 illustrates another example network area that has been covered by repeating a first smaller, two-dimensional grid twice and by repeating a second smaller, two-dimensional grid twice, in accordance with aspects of the present application; and

FIG. 25 illustrates an example of the use of more than one grid at the same time, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

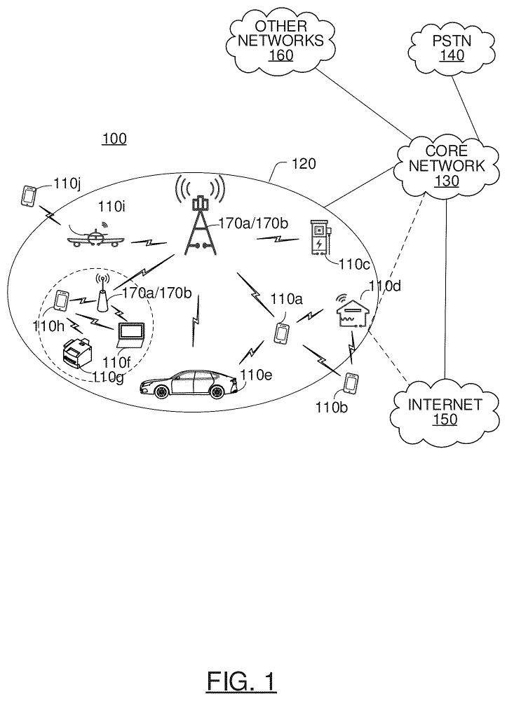

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

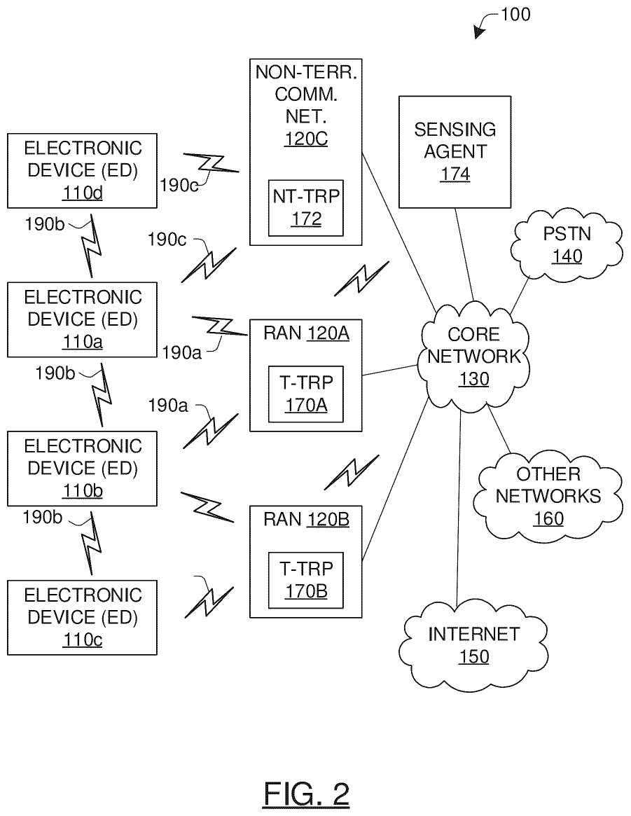

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 1900 can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

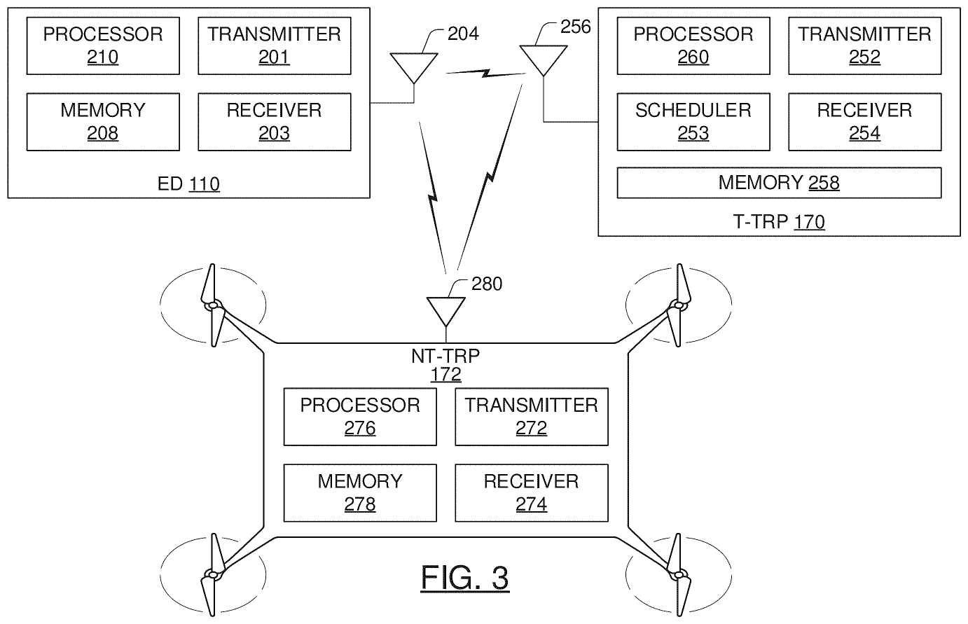

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything(V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding(e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding(e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

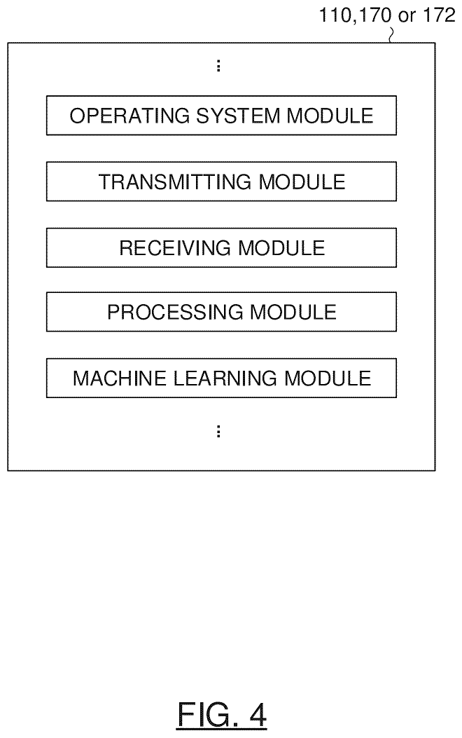

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning(ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing(OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occur on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing(“numerology 1”) and the NR frame structure for normal CP 30 kHz subcarrier spacing(“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing(SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

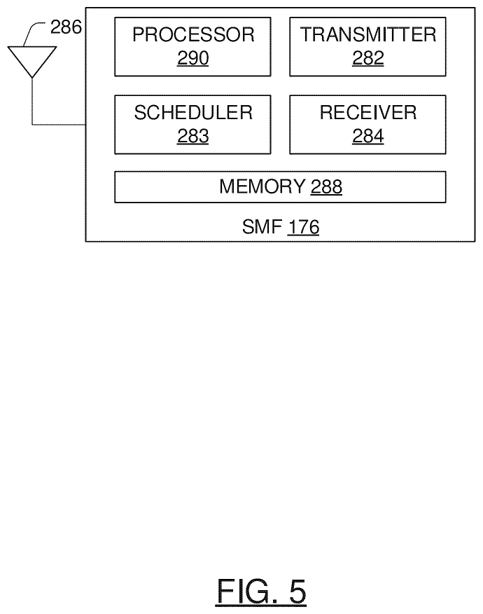

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing(OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f-f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving(other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP 172 may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

In future wireless communication systems, it is anticipated that a network of nodes with sensing capabilities will be the norm. In sensing applications, a sensing state (denoted by S in the present application) may be defined for any node in the network. The definition of a sensing state, S, may be understood to be scenario dependent. Additionally, the definition of a sensing state, S, in a particular system may be understood to be based on needs of the particular system. In general, the definition of a sensing state, S, may be understood to include any sensing-related parameter. Example sensing-related parameters include, but are not limited to: position (a vector); velocity (a vector, the derivative of position with respect to time); orientation (a vector); and angle of arrival (a vector).

Some of the sensing nodes in the network may have fixed sensing states. For example, network transmit receive points (TRPs) or fixed sensor nodes may have fixed sensing states. For such nodes, the sensing state can be associated with a respective node identifier (ID) because the sensing state is fixed. However, in future networks, most of the sensing nodes are predicted to be mobile nodes. For such nodes, the sensing state is expected to be variable and time variant.

With regard to sensing measurement, it is known that a sensing transmitter (sensing TX) transmits a sensing signal, x(t), and a sensing receiver (sensing RX) performs measurement on a received sensing signal, x_{R}(t). The objective is to estimate a sensing state, S_{R}, of the sensing RX. Notably, the parameters measured by the sensing RX are normally relative to a sensing state, S_{T}, of the sensing TX. It follows that estimating the sensing state, S_{R}, at the sensing RX may be expected to make use of: knowledge of the sensing state, S_{T}, of the sensing TX; and measurements performed on the received sensing signal, x_{R} (t). In consideration of a scenario where sensing state is defined around the position sensing parameter. The measurements performed on the received sensing signal, x_{R} (t), may be shown to provide a range and an angle of arrival that are both relative to the sensing TX. Therefore, the position of the sensing RX (i.e., the sensing state, S_{R}, at the sensing RX, in the present example) can be estimated based on the measurements performed on the received sensing signal, x_{R} (t), if the knowledge of the position of the sensing TX is available. In general, an equation, S_{R}=S++g(x(t), x_{R}(t)), may be used, where a function, g(a, b), may be used to represent some degree of post processing.

Typically, the measurements may only be expected to provide a difference of sensing states between the sensing RX and the sensing TX, which may be represented as S_{R}-S_{T}. It follows that, to be able to estimate the sensing state, S_{R}, of the sensing RX, which is the objective, the sensing state, S_{T}, of the sensing TX is important to have in addition to the measurements.

Conventionally, an explicit approach is employed to estimate the sensing state, S_{R}, of the sensing RX. In a conventional approach, the sensing signal x(t) is chosen to be a function of a node ID associated with the sensing TX. It follows that, upon processing measurements of the received sensing signal, x_{R} (t), the sensing RX may be able to extract, from the measurement, a node ID and, thereby, identify the sensing TX that transmitted the sensing signal. The sensing RX may also estimate the sensing state difference, S_{R}-S_{T}, from the measurements. If the sensing TX is a mobile device, the sensing RX does not necessarily have up-to-date information on the sensing state, S_{T}, of the sensing TX because the sensing state of a mobile node is time-varying. For this reason, the sensing RX may transmit the measurements along with the identity of the sensing TX to a network entity, such as the SMF 176, where the sensing state, S_{T}, of the sensing TX is more likely to be known. Subsequently, the SMF 176 can estimate the sensing state, S_{R}, of the sensing RX from the reported measurements using the knowledge of the sensing state, S_{T}, of the sensing TX. Eventually, the SMF 176 may indicate, to the sensing RX, the estimated sensing state, S_{R}, of the sensing RX.

The conventional approach may be considered to have two major disadvantages: latency; and power consumption. The conventional approach may be considered to create a relatively large latency and overhead due to a need for an information exchange between the sensing RX and a network entity (e.g., the SMF 176). It is expected that several future sensing applications will have relatively tight latency requirements. It may be considered that the conventional approach would not be able to meet such relatively tight latency requirements.

An information exchange between the sensing RX and the network entity may be shown to increase power consumption at the sensing RX relative to not exchanging information. Unfortunately, if the sensing RX is a node operating in a low power mode, the sensing RX may not be able to afford the power consumption associated with exchanging information with the network entity. Accordingly, conventional approaches may be shown to be unavailable for use in many low power sensing applications.

It may be considered that a main source of the shortcomings of conventional approaches is that the transmitted sensing signal, x(t), is defined based on the identity of the sensing TX. It follows that, when the sensing RX lacks knowledge of the sensing state, S_{T}, of the sensing TX, the sensing RX also lacks an ability to estimate the sensing state, S_{R}, of the sensing RX.

For example, in 5G NR (see 3GPP TSG RAN WG1 Meeting #96, R1-1901980, Athens, Greece, 25 February-1 Mar. 2019), there have been discussions around a paradigm that involves using a cell-ID-based positioning reference signal (PRS) or a UE-ID-based PRS for positioning. In both cases, the PRS is related to the ID of a node, either the UE or base station of the cell.

This paradigm may be shown to stem from a communication-centric mindset. In a communication-centric mindset, it may be considered that the identity of the sensing TX is always important. Accordingly, the identity of the sensing TX is embedded in the transmitted signal. However, tenets of the communication-centric mindset do not necessarily apply to the task of sensing. In many scenarios, the sensing state, S_{T}, of the sensing TX is much more important than the identity of the sensing TX. For example, consider a scenario wherein a sensing RX is only interested in estimating its own position. In such a scenario, the sensing RX does not need information about the identity of the sensing TX node. It is important to the sensing RX to obtain an estimate for the position of the sensing TX. However, the position of the sensing TX, which leads to the sensing state, S_{T}, of the sensing TX, is important, as the position of the sensing TX is used in the estimation of sensing RX position which leads to the sensing state S_{R}, of the sensing RX.

In overview, aspects of the present application relate to sensing signal design. Sensing signals designed according to aspects of the present application may be shown to overcome disadvantages of conventional sensing signal design methods. Particular aspects of the present application relate to a state-based design for sensing signal. The state-based design stands in contrast to a known ID-based design. In approaches representative of aspects of the present application, a sensing signal, x(t), may be designed as a function of the sensing state, S_{T}, of the sensing TX. Additionally, the design of the sensing signal may take into account an identity of the sensing TX.

A general form for a state-based design for a sensing signal, x(t), may be expressed mathematically, as x(t)=w(S_{T}, SeID), where w(.) denotes a waveform function, relating input parameters to waveform parameters, and where SeID represents an identity for the sensing TX. As mentioned hereinbefore, there need not be a relation between the sensing signal, x(t), and the identity, SeID, of the sensing TX. When the identity, SeID, of the sensing TX has been eliminated, the general form may be simplified to a more specific form, x(t)=w(S_{T}). This more specific form of state-based sensing signal design enables the sensing RX to obtain the sensing state, S_{T}, of the sensing TX from the measurements. It follows that the sensing RX may estimate the sensing state, S_{R}, of the sensing RX without a signaling exchange with a network entity.

According to aspects of the present application, the sensing signal, transmitted by the sensing TX, is constructed in such a way as to embed a sensing state (e.g., a position vector, a velocity vector) of the sensing TX. The embedding of the sensing state in the sensing signal may be shown to allow the sensing RX to obtain the sensing state of the sensing TX without exchanging information with a network entity. Embedding the sensing state of the sensing TX in the transmitted sensing signal can be implemented through mapping the sensing state of the sensing TX to various parameters of the sensing signal. It follows that, in a case wherein two distinct sensing TXs have different sensing states (e.g., the two distinct sensing TXs are in different locations), the two distinct sensing TXs will be expected, according to aspects of the present application, to use distinct sensing signal parameters when constructing their respective sensing signals.

Aspects of the present application may be shown to be applicable to multi-static sensing scenarios, wherein multiple sensing TXs send their sensing signals and one or multiple target nodes, performing as sensing RXs, receive the sensing signals and estimate their respective sensing state (e.g., position vector, velocity vector, orientation) by obtaining measurements of received sensing signals and processing the measurements. It is notable that multi-static sensing is anticipated to be an important service in future 6G systems. Indeed, multi-static sensing is expected to allow for creation of a flexible platform for network-wide sensing in which there is potential for every node to benefit from the sensing services. Aspects of the present application relate to the nodes performing as sensing TXs. Aspects of the present application relate to defining and constructing the sensing signal at the sensing TX so that the sensing state of the sensing TX is embedded in the sensing signal.

In aspects of the present application, the sensing state may be chosen to be a position in two-dimensional plane. To embed the position of each sensing TX in the sensing signal transmitted by each sensing TX, parameters of the sensing signal may be selected based on the position of the sensing TX.

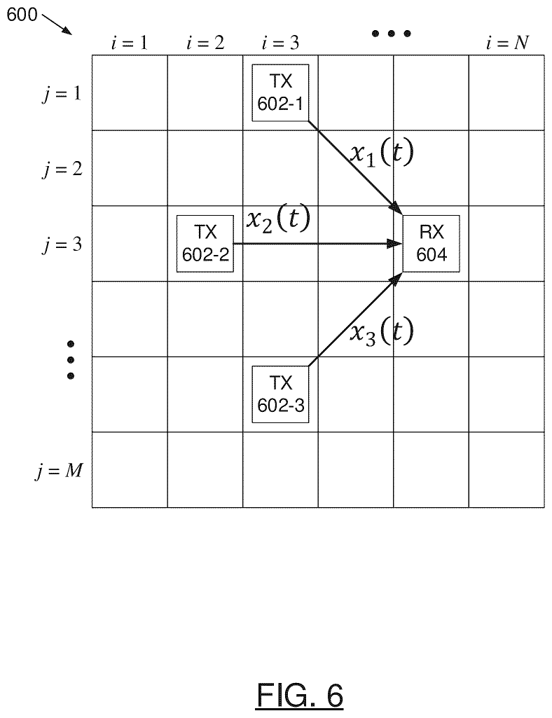

FIG. 6 illustrates a region of interest divided into an M by N position grid 600. Positioned within the region of interest, and, accordingly, on the position grid 600, are a first sensing TX node 602-l, a second sensing TX node 602-2 and a third sensing TX node 602-3 (collectively or generically 602). Additionally, a sensing RX node 604 is positioned within the region of interest.

Recall that, according to aspects of the present application, distinct sensing signal parameters are to be used, by each sensing TX node 602 among a plurality of sensing TXs node 602, when constructing their respective sensing signals. The choice of a particular sensing signal parameter may depend on grid indices with which a given sensing TX node 602 is associated. Mappings may be defined to establish a value of a sensing signal parameter based on the location of the given sensing TX node 602 within the region of interest.

The location of the given sensing TX node 602 within the region of interest is, in general, expected to be a highly accurate three-dimensional vector. The position grid 600 illustrated in FIG. 6 helps to broadly define the location of the given sensing TX node 602 within the two-dimensional region of interest. That is, the position grid 600 illustrated in FIG. 6 acts to simplify a highly accurate, three-dimensional vector down to a two-dimensional vector. The two-dimensional vector may be expressed as a pair of indices defining a zone within the two-dimensional grid overlaying the region of interest. Notably, the grid need not be defined on only two dimensions. Indeed, a grid may be defined on three or more dimensions without deviating from aspects of the present application, the definition of the grid is intended to quantize position and, thereby, reduce overhead.

Reasons for defining a grid, such as the two-dimensional position grid 600 overlaying the region of interest in FIG. 6, include recognizing that a set of possible configuration parameters for the sensing signal is limited. Accordingly, there may be difficulty experienced when trying to uniquely map the set of possible configuration parameters for the sensing signal to all of possible locations of the given sensing TX node 602 when the possible locations are expressed as a vector with three or more dimensions. It follows that quantizing the location of the given sensing TX node 602 may be carried out by, first, forming a position grid and, second, defining a mapping between the set of possible configuration parameters and various locations within the position grid 600. The size of the position grid 600 may be configured based on a degree to which positioning accuracy is desired for the sensing TX node 602.

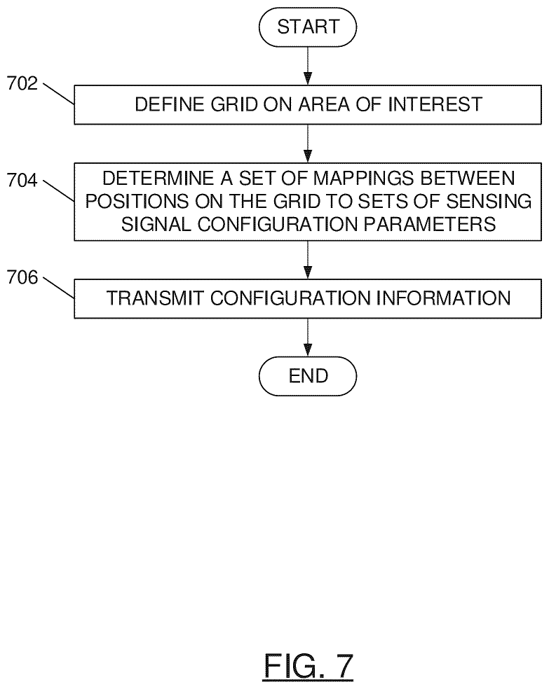

Steps of a method representative of aspects of the present application are illustrated as a flowchart in FIG. 7 from the perspective of the SMF 176. Initially, the SMF 176 (or other network entity configured to carry out network-based, sensing-related tasks) may define (step 702) a position grid on an area of interest. As discussed briefly hereinbefore, each rectangular area on the position grid, as identified by indices, may be mapped (step 704), by the SMF 176, to a set of configuration parameters for a sensing signal, thereby producing a set of mappings. The SMF 176 may transmit (step 706) the set of mappings to all potential sensing TX nodes 602 and to all potential sensing RX nodes 604. The transmission (step 706) of the set of mappings may be accomplished, by the SMF 176, using RRC signaling. Each of the transmitted mappings may be expressed in the form of a formula or as a portion of a look-up table. Some detailed examples for such mappings will be provided hereinafter. Notably, transmission (step 706) of the set of mappings may be configured to be carried out once in a while. That is, transmission (step 706) of the set of mappings need not be configured to be dynamic.

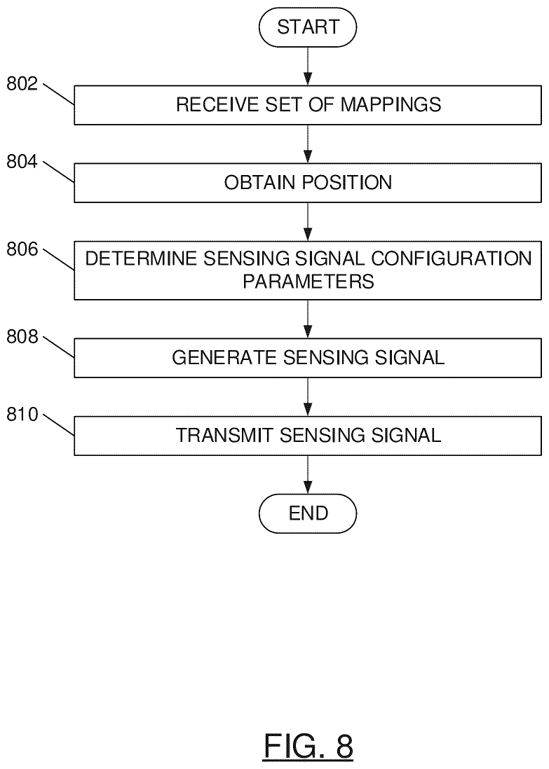

Steps of a method representative of aspects of the present application are illustrated as a flowchart in FIG. 8 from the perspective of one of the sensing TX nodes 602. Following the transmission (step 706) of the set of mappings by the SMF 176, the sensing TX node 602 receives (step 802) the set of mappings. Once the sensing TX node 602 has obtained (step 804) its position on the position grid 600, the sensing TX node 602 may use the position on the position grid 600 in combination with the received set of mappings to, thereby, determine (step 806) sensing signal configuration parameters to use when transmitting a sensing signal. The sensing TX node 602 may then generate (step 808) a sensing signal according to the sensing signal configuration parameters. The sensing TX node 602 may then transmit (step 810) the generated sensing signal.

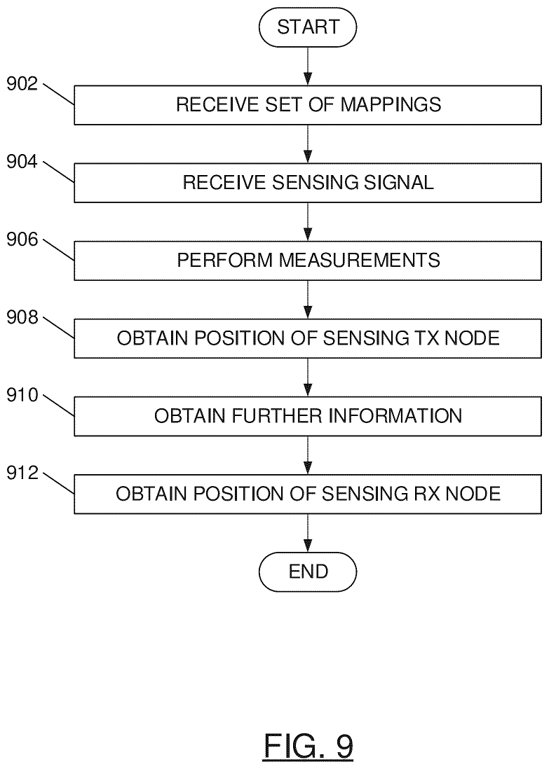

Steps of a method representative of aspects of the present application are illustrated as a flowchart in FIG. 9 from the perspective of one of the sensing RX nodes 604. Following the transmission (step 706) of the set of mappings by the SMF 176, the sensing RX node 604 receives (step 902) the set of mappings. Following the transmission (step 810) of the sensing signal by the sensing TX node 602, the sensing RX node 604 receives (step 904) the sensing signal. The sensing RX node 604 may then perform (step 906) measurement on the received sensing signal. Through processing the measurements, the sensing RX node 604 may obtain configuration parameters of the received sensing signal. Using the mappings that the sensing RX node 604 has received (step 902), the sensing RX node 604 may obtain (step 908) a quantized position of the sensing TX node 602. Through processing the measurements, the sensing RX node 604 may also obtain (step 910) further information. For one example, the further information may include a range to associate with the sensing TX node 602. For another example, the further information may include an angle of arrival to associate with the sensing signal. The sensing RX node 604 may then obtain (step 912) its position. Obtaining (step 912) its position may involve the sensing RX node 604 using the quantized position of the sensing TX node 602 (obtained in step 908) in combination with the further information (obtained in step 910). Obtaining(step 912) its position may, for one example, involve the sensing RX node 604 applying the known Time Difference of Arrival (TDoA) positioning method. Obtaining(step 912) its position may, for another example, involve the sensing RX node 604 applying the known Angle of Arrival (AoA) positioning method. Obtaining(step 912) its position may, for a further example, involve the sensing RX node 604 applying a combination of the TDoA positioning method and the AoA positioning method. The TDoA positioning method and the AoA positioning method are standard positioning methods and are defined in 5G standards.

It may be considered that there are an integer number, L, of the sensing TX nodes 602 in the region of interest in FIG. 6. Each of the sensing TX nodes 602 may be a mobile UE or some other type of network node or a combination of a mobile UE and some other type of network node. In the example provided in FIG. 6, three (L=3) sensing TX nodes 602 are illustrated. It may be assumed that that the sensing TX nodes 602 have already determined their respective position in the region of interest.

Consider that the sensing RX node 604, in FIG. 6, is to estimate its position. Note that the sensing RX node 604 may also be called a target UE 604 or a target node 604. In aspects of the present application, each sensing TX node 602 transmits (step 810, FIG. 8) a sensing signal, wherein the sensing signal is a function of the position of the sensing TX node 602 on the position grid 600 in the region of interest. More specifically, configuration parameters of the sensing signal of each sensing TX node 602 are mapped to a “sensing state” of the respective sensing TX node 602. In an aspect of the present application, the “sensing state” of the sensing TX node 602 is the position, on the position grid 600 in the region of interest, of the respective sensing TX node 602. In general, the sensing signal transmitted by the l^{th} sensing TX node 602-l may be defined as xₗ(t)=w(ηₗ), where w(·) is a waveform function.

Additionally, ηₗ represents the position of the l^{th} sensing TX node 602-l on the position grid 600, i.e., in view of FIG. 6, nₗ=(iₗ, jₗ), where it and jₗ are indices of a rectangular area on the position grid 600 within which the l^{th} sensing TX node 602-l is located. Notably, if a given sensing TX node 602 is not exactly located within a particular area, the given sensing TX node 602 may be associated with a closest grid area.

In the example illustrated in FIG. 6, a first sensing signal, xₗ(t), is illustrated as having been transmitted from the first sensing TX node 602-l, a second sensing signal, x₂ (t), is illustrated as having been transmitted from the second sensing TX node 602-2 and a third sensing signal, x₃ (t), is illustrated as having been transmitted from the third sensing TX node 602-3. It follows that the sensing RX node 604 receives (step 904, FIG. 9) multiple sensing signals, one sensing signal from each sensing TX node 602, with each sensing signal generated to have distinct configuration parameters. The sensing RX node 604 may obtain (step 908, FIG. 9) a quantized position of the sensing TX node 602 of each sensing signal by estimating the configuration parameters of the received sensing signal.

Additionally, the sensing RX node 604 may obtain (step 910, FIG. 9) further information. As discussed hereinbefore, the further information may include a range to associate with the sensing TX node 602 and an angle of arrival to associate with the sensing signal. The sensing RX node 604 may then obtain (step 912) its position. Obtaining(step 912) its position may involve the sensing RX node 604 using the quantized position of the sensing TX node 602 (obtained in step 908) in combination with the further information (obtained in step 910).

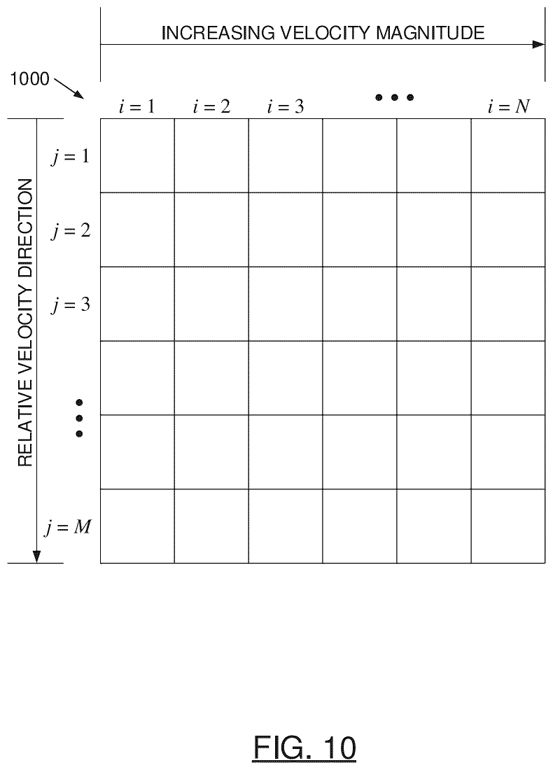

Aspects of the present application relate to a velocity-based sensing signal design. That is, the sensing state of the sensing TX node is chosen to be velocity of the sensing TX node. It may be shown that such a sensing signal design helps the sensing RX node to estimate a velocity of the sensing TX node. In a manner consistent with aspects of the present application disclosed hereinbefore, a grid may be defined. In this aspect, the grid may be used to represent a velocity vector. A velocity vector is known to have a direction (an angle, which may be represented as a vector), a, and a magnitude, v. Through the use of a velocity grid defined in this way, a velocity vector for a given sensing TX node may be quantized as a rectangular area on the defined velocity grid. The quantized velocity vector may then be associated with the given sensing TX node. FIG. 10 illustrates an example, wherein a velocity vector space has been divided into an M by N velocity vector grid 1000. A horizontal grid axis for the velocity vector grid 1000 is associated with a magnitude scalar for the velocity vector and a vertical grid axis for the velocity vector grid 1000 is associated with a direction associated with a velocity vector. The direction may be expressed with respect to an agreed-upon base direction. Notably, the velocity vector grid 1000 of FIG. 10 should only be regarded as an example velocity vector grid, since it is contemplated that there are other ways to define a grid on a velocity space. For an alternative velocity vector grid (not shown), each velocity vector may be decomposed into an x component, a y component and a z component, instead of magnitude and phase (direction/angle vector, hereinbefore). It should be clear that the type of grid utilized may be varied to fit to certain applications.

Determining, at a given sensing TX node, configuration parameters for a sensing signal that is to be transmitted, may be shown to involve self-determination of velocity and determination of position indices in the velocity vector grid 1000 of FIG. 10. It may be expected that a mapping exists between velocity grid indices and configuration parameters for a sensing signal. It follows that determining configuration parameters for a sensing signal may involve using the mapping in combination with the indices. Notably, the velocity grid may be configured to have limits and granularity based on a desired accuracy for a velocity estimation that is to occur at a sensing RX node.

From the perspective of the SMF 176, establishing a velocity grid and related mappings may proceed in a manner consistent with establishing a position grid and related mappings, as illustrated in FIG. 7. Initially, the SMF 176 (or other network entity configured to carry out network-based, sensing-related tasks) may define (step 702) a grid on a velocity space of interest. Each rectangular area associated with a pair of indices on the velocity vector grid 1000 may be mapped (step 704), by the SMF 176, to a set of configuration parameters for a sensing signal, thereby producing a set of mappings. The SMF 176 may transmit (step 706) the set of mappings to all potential sensing TX nodes and to all potential sensing RX nodes. The transmission (step 706) of the set of mappings may be accomplished, by the SMF 176, using RRC signaling. Each of the transmitted mappings may be expressed in the form of a formula or as a portion of a look-up table. Some detailed examples for such mappings will be provided hereinafter. Notably, transmission (step 706) of the set of mappings may be configured to be carried out once in a while. That is, transmission (step 706) of the set of mappings need not be configured to be dynamic.

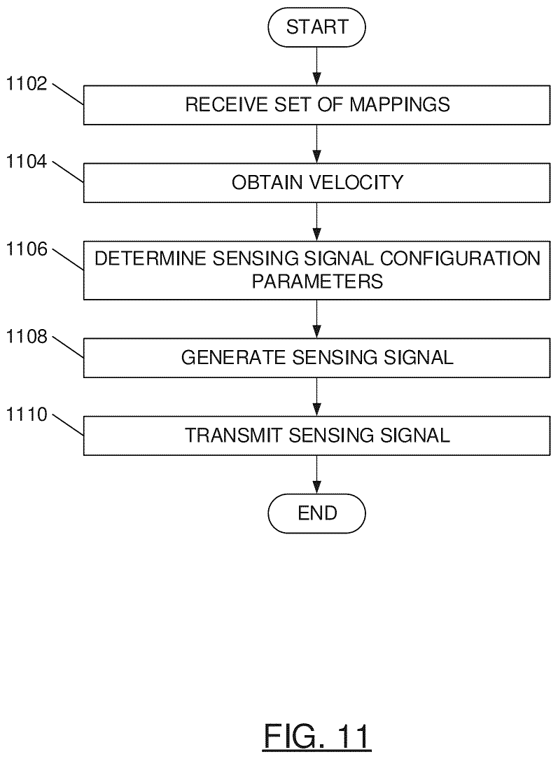

Steps of a method representative of aspects of the present application are illustrated as a flowchart in FIG. 11 from the perspective of one of the sensing TX nodes. Following the transmission (step 706) of the set of mappings by the SMF 176, the sensing TX node receives (step 1102) the set of mappings. Once the sensing TX node has obtained (step 1104) its velocity vector, the sensing TX node may determine, based on the magnitude and direction of the velocity vector, indices on the velocity vector grid 1000. Once the sensing TX node has determined the indices on the velocity vector grid 1000, the sensing TX node may use the indices on the velocity vector grid 1000 in combination with the received set of mappings to, thereby, determine (step 1106) sensing signal configuration parameters to use when transmitting a sensing signal. The sensing TX node may then generate (step 1108) a sensing signal according to the sensing signal configuration parameters. The sensing TX node may then transmit (step 1110) the generated sensing signal.

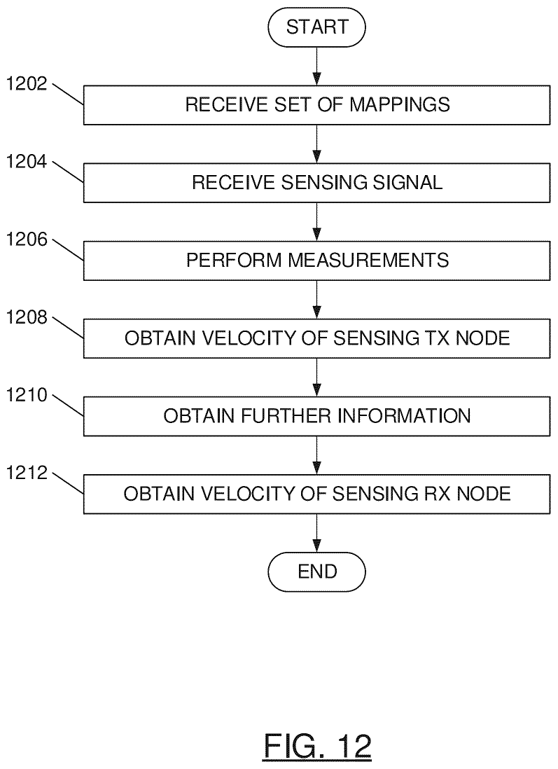

Steps of a method representative of aspects of the present application are illustrated as a flowchart in FIG. 12 from the perspective of one of the sensing RX nodes. Following the transmission (step 706) of the set of mappings by the SMF 176, the sensing RX node receives (step 1202) the set of mappings. Following the transmission (step 1110) of the sensing signal by the sensing TX node, the sensing RX node receives (step 1204) the sensing signal. The sensing RX node may then perform (step 1206) measurement on the received sensing signal. Through processing the measurements, the sensing RX node may obtain configuration parameters of the received sensing signal. Using the mappings that the sensing RX node has received (step 1202), the sensing RX node may obtain (step 1208) a velocity vector for the sensing TX node. Through processing the measurements, the sensing RX node may also obtain (step 1210) further information. For one example, the further information may include an angle of arrival to associate with the sensing signal. For another example, the further information may include a doppler frequency shift to which each sensing signal has been subjected due to a velocity difference between the sensing RX node and the sensing TX node. The sensing RX node may then obtain (step 1212) its velocity. Obtaining(step 1212) its velocity may involve the sensing RX node using the quantized velocity of the sensing TX node (obtained in step 1208) in combination with the further information (obtained in step 1210).

Consider that the sensing RX node, in FIG. 6, is to estimate its velocity. In aspects of the present application, each sensing TX node transmits (step 1110, FIG. 11) a sensing signal, wherein the sensing signal is a function of the velocity of the sensing TX node on the velocity vector grid 1000 defined over a velocity space. Using awareness of its velocity vector, each sensing TX node may generate (step 1108, FIG. 11) a sensing signal using a mapping that has been received (step 1102, FIG. 11) by the sensing TX node. Let v denote a quantized transmitter velocity magnitude for the l^{th} sensing TX node. Additionally, let a represent a quantized transmitter velocity direction of the l^{th} sensing TX node. Let nₗ=(iₗ, jₗ) represent the indices of a rectangular area on the velocity vector grid 1000 that is associated with a velocity vector for the l^{th} sensing TX node. The sensing signal transmitted (step 1110, FIG. 11) by the l^{th} sensing TX node, i.e., xₗ(t), may be expressed as xₗ(t)=w(n.), where w(·) is a waveform function. The sensing RX node may obtain (step 1208, FIG. 12) a value for the quantized transmitter velocity magnitude, vₗ, and a quantized transmitter velocity direction, aₗ, by estimating the configuration parameters of the sensing signal that has been received (step 1204, FIG. 12) at the sensing RX node. Obtaining(step 1208, FIG. 12) components, (vₗ, aₗ), of the velocity vector for the sensing TX node that transmitted the sensing signal may involve using the mapping received, by the sensing RX node, in step 1202.

As discussed hereinbefore, using the results of performing measurements (step 1206, FIG. 12), the sensing RX node may obtain (step 1210, FIG. 12) an AoA, ϕ_{R}, and a doppler frequency shift, f_{D}. Furthermore, the sensing RX node may be understood have an ability to measure a receiver velocity direction, α_{R}. The receiver velocity direction, α_{R}, may be expressed with respect to the same agreed-upon base direction in respect of which the quantized transmitter velocity direction, αₗ, is expressed. In one example, the sensing RX node may obtain the receiver velocity direction, α_{R}, using a compass. Given the obtained values of f_{D}, ϕ_{R}, vₗ and αₗ, the sensing RX node may use a known doppler shift formula,

$${f}_{D} = \frac{{v}_{l} cos ( {ϕ}_{R} + {α}_{l} ) - {v}_{R} cos ( {ϕ}_{R} + {α}_{R} )}{λ} ,$$

to obtain a receiver velocity magnitude, v_{R}, for the sensing RX node. Notably, the receiver velocity magnitude, v_{R}, for the sensing RX node, is the only unknown term in the doppler shift formula. Further notably, the doppler shift formula includes a wavelength term, λ, whose value is known for the sensing signal.

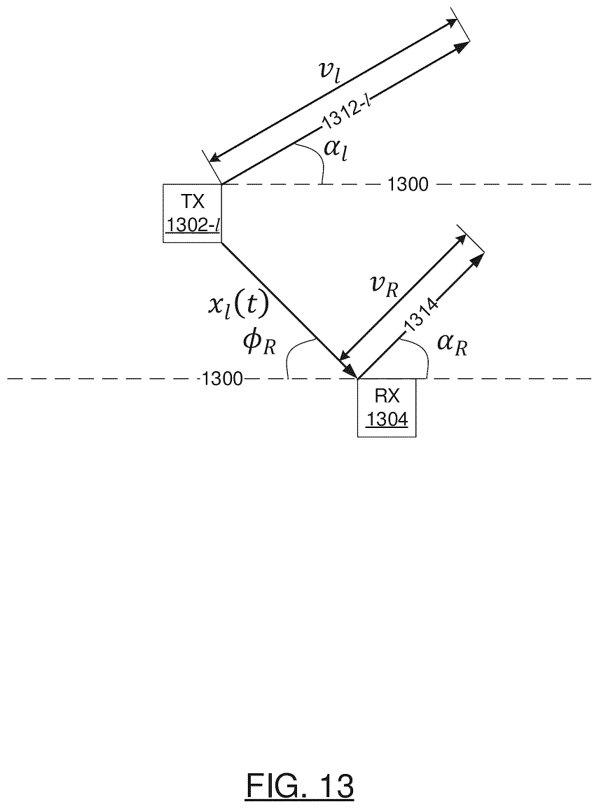

A review of the various terms used in the doppler shift formula are illustrated in FIG. 13. FIG. 13 illustrates a sensing TX node 1302-l and a sensing RX node 1304. The sensing TX node 1302-l is associated with a transmitter velocity vector 1312-l. The sensing RX node is associated with a receiver velocity vector 1314. The transmitter velocity vector 1312-l is associated with a transmitter velocity magnitude, vₗ. The transmitter velocity vector 1312-l is associated with a transmitter velocity direction, αₗ, measured relative to an agreed-upon base direction 1300. The receiver velocity vector 1314 is associated with a receiver velocity magnitude, v_{R}. The receiver velocity vector 1314 is associated with a receiver velocity direction, α_{R}, measured relative to the agreed-upon base direction 1300. The sensing TX node 1302-l is illustrated transmitting a sensing signal, xₗ(t), which is associated with an AoA, ϕ_{R}, measured relative to the agreed-upon base direction 1300.

Aspects of the present application relate to a channel subspace-based sensing signal design. That is, the sensing state of the sensing TX node is chosen to be a channel subspace of the sensing TX node.

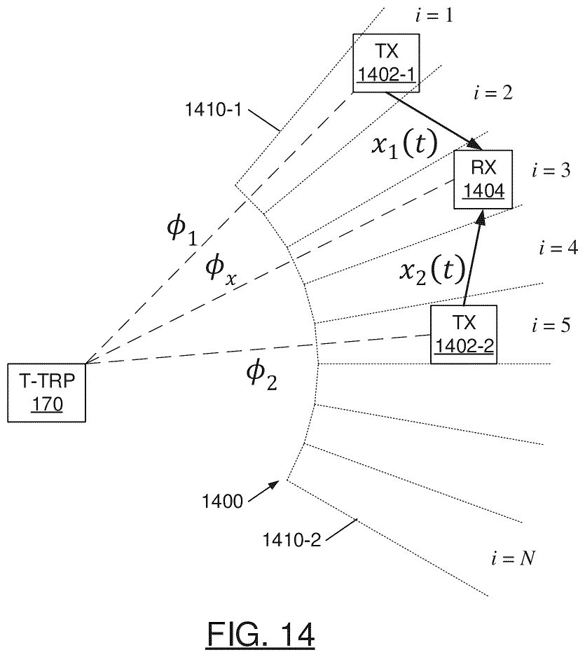

A channel space may be defined as a range of AoA for signals received from a TRP 170. FIG. 14 illustrates a channel space bounded by a first boundary AoA 1410-1 and a second boundary AoA 1410-2. A channel subspace may also be defined as a range of AoA for signals received from a TRP 170. FIG. 14 illustrates that the channel space bounded by the first boundary AoA 1410-1 and the second boundary AoA 1410-2 may be divided into a one-dimensional angular grid 1400 that includes N channel subspaces.

FIG. 14 illustrates a first sensing TX node 1402-l, a second sensing TX node 1402 and a sensing RX node 1404. The first sensing TX node 1402-l is associated with a first AoA, ϕ1, for signals received from the TRP 170. The first AoA, ϕ1, is within a channel subspace associated with an index, i=1. The second sensing TX node 1402-2 is associated with a second AoA, ϕ2, for signals received from the TRP 170. The second AoA, ϕ2, is within a channel subspace associated with an index, i=5. The sensing RX node 1404 is associated with an unknown AoA, x, for signals received from the TRP 170. It may be shown that receipt of a channel subspace-based sensing signal may allow the sensing RX node 1404 to obtain the index of the channel subspace in which the sensing RX node 1404 is located and, thereby, estimate the unknown AoA, ox, for signals received, at the sensing RX node 1404, from the TRP 170. Notably, with the proposed method, the sensing RX node 1404 may be able to estimate its AoA, ϕ_{T}, even in the absence of a received signal from the TRP 170.

Aspects of the present application involve forming the one-dimensional angular grid 1400 on the basis of AoAs of signals from the TRP 170. Using a grid of the type illustrated in FIG. 14, an AoA associated with each sensing TX node 1402 may be quantized as being within one of the channel sub-spaces in the one-dimensional angular grid 1400.

From the perspective of the SMF 176, establishing a one-dimensional angular grid and related mappings may proceed in a manner consistent with establishing a position grid and related mappings, as illustrated in FIG. 7. Initially, the SMF 176 (or other network entity configured to carry out network-based, sensing-related tasks) may define (step 702) a one-dimensional angular grid on a channel space of interest. Each channel subspace associated with a single index on the one-dimensional angular grid 1400 may be mapped (step 704), by the SMF 176, to a set of configuration parameters for a sensing signal, thereby producing a set of mappings. The SMF 176 may transmit (step 706) the set of mappings to all potential sensing TX nodes and to all potential sensing RX nodes. The transmission (step 706) of the set of mappings may be accomplished, by the SMF 176, using RRC signaling. Each of the transmitted mappings may be expressed in the form of a formula or as a portion of a look-up table. Notably, transmission (step 706) of the set of mappings may be configured to be carried out once in a while. That is, transmission (step 706) of the set of mappings need not be configured to be dynamic.

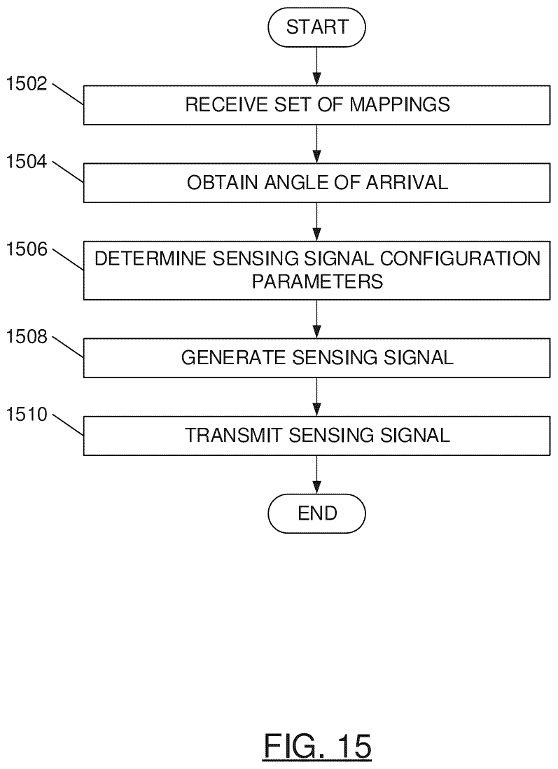

Steps of a method representative of aspects of the present application are illustrated as a flowchart in FIG. 15 from the perspective of one of the sensing TX nodes 1402. Following the transmission (step 706) of the set of mappings by the SMF 176, the sensing TX node 1402 receives (step 1502) the set of mappings. Once the sensing TX node 1402 has obtained (step 1504) its AoA of signals from the TRP 170, the sensing TX node 1402 may determine an index on the one-dimensional angular grid 1400. Once the sensing TX node 1402 has determined the index on the one-dimensional angular grid 1400, the sensing TX node 1402 may use the index in combination with the received set of mappings to, thereby, determine (step 1506) sensing signal configuration parameters to use when transmitting a sensing signal. The sensing TX node 1402 may then generate (step 1508) a sensing signal according to the sensing signal configuration parameters. The sensing TX node may then transmit (step 1510) the generated sensing signal.

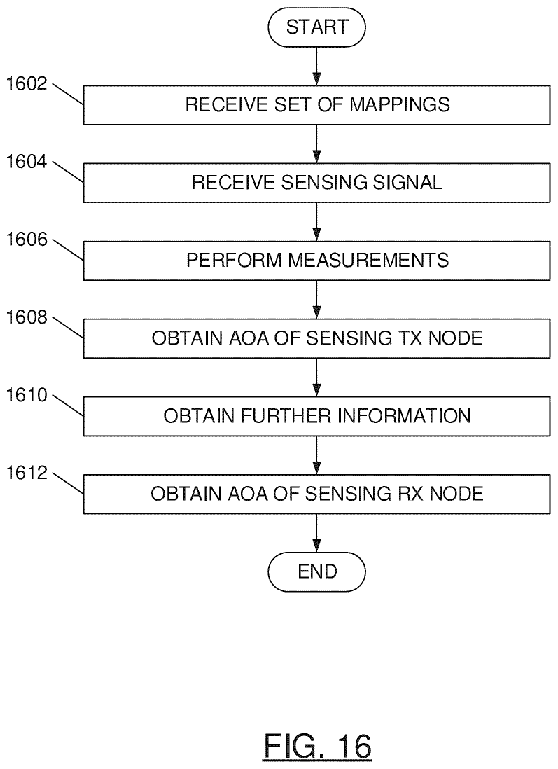

Steps of a method representative of aspects of the present application are illustrated as a flowchart in FIG. 16 from the perspective of the sensing RX nodes. Following the transmission (step 706) of the set of mappings by the SMF 176, the sensing RX node 1404 receives (step 1602) the set of mappings. Following the transmission (step 1510) of the sensing signal by one of the sensing TX nodes 1402, the sensing RX node 1404 receives (step 1604) the sensing signal. The sensing RX node 1404 may then perform (step 1606) measurement on the received sensing signal. Through processing the measurements, the sensing RX node 1404 may obtain configuration parameters of the received sensing signal. Using the mappings that the sensing RX node has received (step 1602), the sensing RX node 1404 may obtain (step 1608) a quantized AoA for the sensing TX node 1402. Through processing the measurements, the sensing RX node 1404 may also obtain (step 1610) further information. For one example, the further information may include an angle of arrival to associate with the sensing signal. The sensing RX node 1404 may then obtain (step 1612) its AoA. Obtaining(step 1612) its AoA may involve the sensing RX node 1404 using the quantized AoA of the sensing TX node 1402 (obtained in step 1608) in combination with the further information (obtained in step 1610) and some geometric methods.

Consider that the sensing RX node 1404, in FIG. 14, is to estimate the unknown AoA, ϕₓ, for signals expected to arrive at the sensing RX node 1404 from the TRP 170. It may be assumed that the sensing TX nodes 1402-l, 1402-2 are aware of, or may obtain an estimate of, their AoA with respect to the TRP 170 (ϕ₁ and ϕ₂ in FIG. 14). Using the knowledge of its AoA with respect to the TRP 170, each sensing TX node 1402 may generate (step 1508, FIG. 15) a sensing signal using the mappings that have been received (step 1502, FIG. 15). A quantized AoA (with respect to the TRP 170) for the l^{th} sensing TX 1402-l may be represented as ϕₗ. A generic index, iₗ, may be used to reference a channel subspace, in the one-dimensional AoA grid 1400, that is associated with the l^{th} sensing TX node 1402-l. A sensing signal, i.e., xₗ(t), transmitted (step 1510, FIG. 15) by the l^{th} sensing TX node 1402-l, may be expressed as xₗ(t)=w(iₗ), where w(·) is a waveform function. The sensing RX node 1404 may obtain (step 1608, FIG. 16) the value of the quantized AoA, ϕ₁, by estimating the parameters of the received sensing signal and using the mapping received by the sensing RX node 1404 in step 1602. Using the measurements, the sensing RX node may also estimate an AoA for the sensing signal received from each sensing TX node 1402. Eventually, using the information of the quantized AoA of each sensing TX node 1402 with respect to the TRP 170 as well as the AoA for the sensing signal received from each sensing TX node 1402, the sensing RX node 1404 may apply geometric approaches to obtain (step 1610, FIG. 16) the unknown AoA, ϕₓ, for signals expected to arrive at the sensing RX node 1404 from the TRP 170.

Aspects of the present application relate to an orientation-based sensing signal design. That is, the sensing state of the sensing TX node is chosen to be an orientation of the sensing TX node. Such an orientation-based sensing signal design may be shown to assist a sensing RX node to estimate its own orientation. For the sake of aspects of the present application, orientation may be defined as rotation with respect to a base axis.

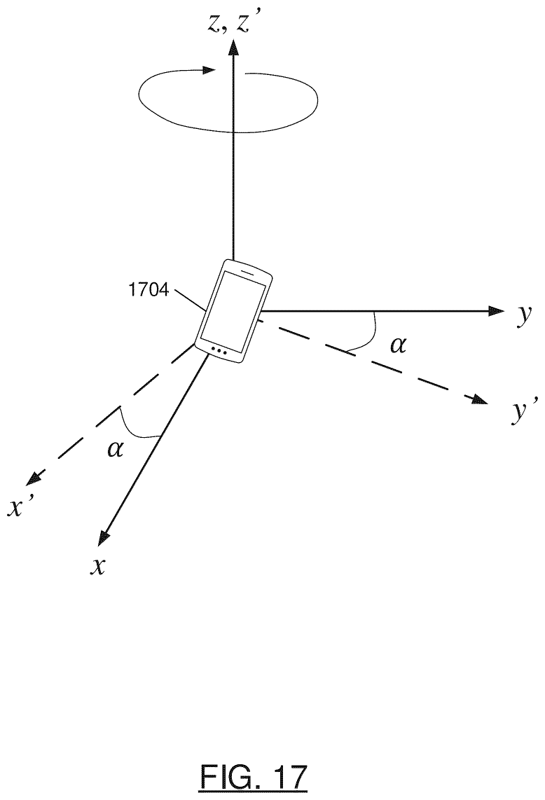

A device 1704 is illustrated, in FIG. 17, in a context formed by a base Cartesian coordinate system with three axes: x; y; and z. In FIG. 17, a particular orientation of the device 1704 is represented by an angular rotation by an angle, a, with respect to the z-axis of the base Cartesian coordinate system. After the angular rotation, a local coordinate system, that is, a coordinate system specific to the reoriented device 1704, may be understood to be represented by three axes: x′; y′; and z′. It should be clear that these aspects of the present application need not be restricted to these three axes. Indeed, aspects of the present application may be extended to include orientation with respect to other axes or, even, may be extended to include orientation with respect to multiple axes together.

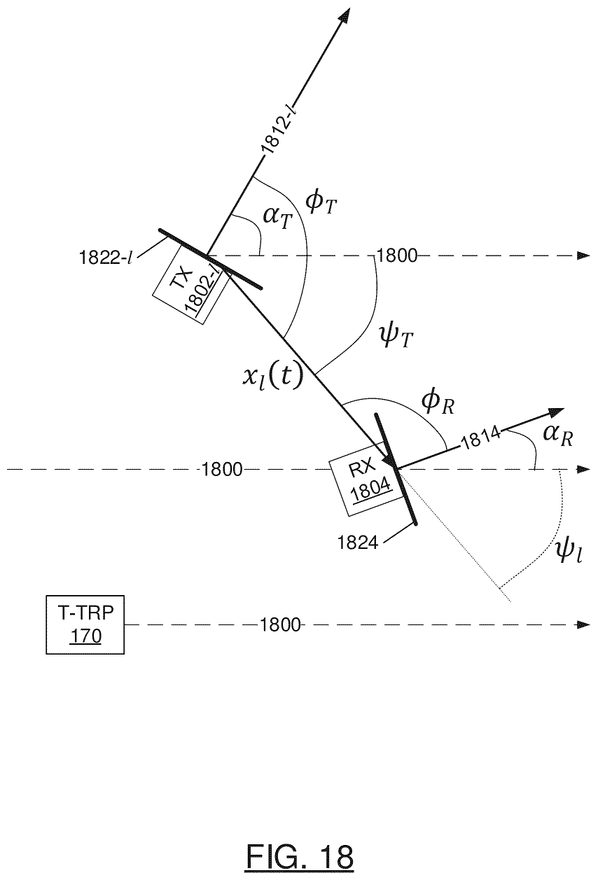

FIG. 18 illustrates a TRP 170, an l^{th} sensing TX node 1802-l and a sensing RX node 1814. The sensing TX node 1802-l is illustrated as having a sensing TX antenna array 1822-l. The sensing TX antenna array 1822-l is illustrated as having a sensing TX antenna array boresight direction 1812-l. The sensing RX node 1804 is illustrated as having a sensing RX antenna array 1824. The sensing RX antenna array 1824 is illustrated as having a sensing RX antenna array boresight direction 1814. On the basis of signals transmitted from the TRP 170, a base direction 1800 may be established. Subsequently, a sensing TX node angular rotation, α_{T}, representative of an orientation of the sensing TX node 1802-l, may be defined with respect to the base direction 1800. Similarly, a sensing RX node angular rotation, α_{R}, representative of an orientation of the sensing RX node 1804 may be defined with respect to the base direction 1800.

FIG. 18 illustrates that there is a sensing signal transmission angle, ϕ_{T}, between a direction of the sensing signal, xₗ(t), and the sensing TX antenna array boresight direction 1812-l. It may be assumed that that the sensing signal transmission angle, ϕ_{T}, is known by the sensing TX node 1802-l.

A TX difference angle, ψ_{T}, may be defined as a difference between the transmission angle, ϕ_{T}, and the sensing TX node angular rotation, α_{T}, that is, ψ_{T}≙ϕ_{T}−α_{T}. A one-dimensional angular grid may be defined based around TX difference angle, ψ_{T}, information.

Aspects of the present application involve forming the one-dimensional TX difference angular grid on the basis of the TX difference angle, ψ_{T}, which is closely related to the orientation of the sensing TX node 1802-l. Each of a plurality of TX difference angle sub-spaces may be associated with a set of sensing signal configuration parameters. Using a TX difference angular grid (not shown), a TX difference angle associated with each sensing TX node 1802 may be quantized as being within one of the TX difference angle sub-spaces in the one-dimensional TX difference angular grid. The size of the TX difference angular grid may be configured based on a degree to which orientation accuracy is desired for the sensing RX node 1804.

From the perspective of the SMF 176, establishing a one-dimensional TX difference angular grid and related mappings may proceed in a manner consistent with establishing a position grid and related mappings, as illustrated in FIG. 7. Initially, the SMF 176 (or other network entity configured to carry out network-based, sensing-related tasks) may define (step 702) a one-dimensional TX difference angle grid on an orientation space of interest. Each range of TX difference angles, associated with a single index on the one-dimensional TX difference angle grid, may be mapped (step 704), by the SMF 176, to a set of configuration parameters for a sensing signal, thereby producing a set of mappings. The SMF 176 may transmit (step 706) the set of mappings to all potential sensing TX nodes and to all potential sensing RX nodes. The transmission (step 706) of the set of mappings may be accomplished, by the SMF 176, using RRC signaling. Each of the transmitted mappings may be expressed in the form of a formula or as a portion of a look-up table. Notably, transmission (step 706) of the set of mappings may be configured to be carried out once in a while. That is, transmission (step 706) of the set of mappings need not be configured to be dynamic.

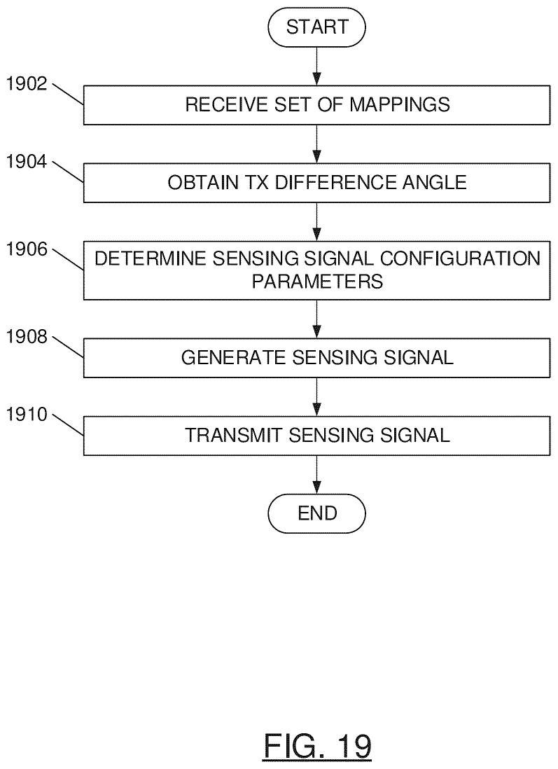

Steps of a method representative of aspects of the present application are illustrated as a flowchart in FIG. 19 from the perspective of one of the sensing TX nodes 1802-l. Following the transmission (step 706) of the set of mappings by the SMF 176, the sensing TX node 1802-l receives (step 1902) the set of mappings. Once the sensing TX node 1802-l has obtained (step 1904) its TX difference angle, wr, the sensing TX node 1802-l may determine an index on the one-dimensional TX difference angle grid. Once the sensing TX node 1802-l has determined the index on the one-dimensional TX difference angle grid, the sensing TX node 1802-l may use the index in combination with the received set of mappings to, thereby, determine (step 1906) sensing signal configuration parameters to use when transmitting a sensing signal. The sensing TX node 1802-l may then generate (step 1908) a sensing signal according to the sensing signal configuration parameters. The sensing TX node may then transmit (step 1910) the generated sensing signal.

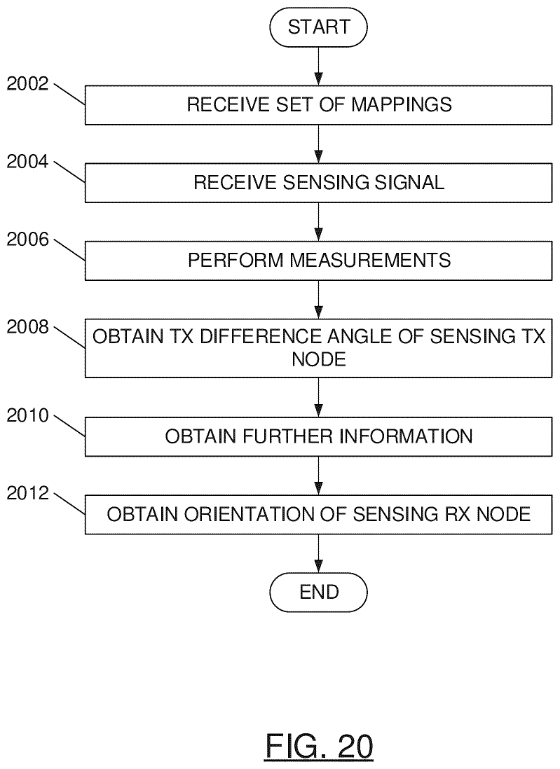

Steps of a method representative of aspects of the present application are illustrated as a flowchart in FIG. 20 from the perspective of the sensing RX node 1804. Following the transmission (step 706) of the set of mappings by the SMF 176, the sensing RX node 1804 receives (step 2002) the set of mappings. Following the transmission (step 1910) of the sensing signal by the sensing TX node 1802-l, the sensing RX node 1804 receives (step 2004) the sensing signal. The sensing RX node 1804 may then perform (step 2006) measurement on the received sensing signal. Through processing the measurements, the sensing RX node 1804 may obtain configuration parameters of the received sensing signal. Using the mappings that the sensing RX node 1804 has received (step 2002), the sensing RX node 1804 may obtain (step 2008) a quantized TX difference angle for the sensing TX node 1802-l. Through processing the measurements, the sensing RX node 1804 may also obtain (step 2010) further information. For one example, the further information may include a sensing signal angle of arrival, ϕ_{R}, determined with reference to the sensing RX antenna array boresight direction 1814 (see FIG. 18). The sensing RX node 1804 may then obtain (step 2012) its orientation. Obtaining(step 2012) its orientation may involve the sensing RX node 1804 using the quantized TX difference angle of the sensing TX node 1802-l (obtained in step 2008) in combination with the further information (obtained in step 2010) and some geometric methods.

Consider that the sensing RX node 1804, in FIG. 18, is to estimate its orientation. It may be assumed that the sensing TX node 1802-l is aware of its own sensing TX node angular rotation, α_{T}, and the transmission angle, ϕ_{T}, such that the sensing TX node 1802-l may determine (step 1904, FIG. 19) the TX difference angle, ψ_{T}. Using the knowledge of the TX difference angle, ψ_{T}, the sensing TX node 1802-l may generate (step 1908, FIG. 19) a sensing signal using the mappings that have been received (step 1902, FIG. 19).

A generic index, iₗ, may be use to reference a range of TX difference angles, in the one-dimensional TX difference angle grid, that is associated with the l^{th} sensing TX node 1802-l. A sensing signal, i.e., xₗ(t), transmitted (step 1910, FIG. 19) by the l^{th} sensing TX node 1802-l, may be expressed as xₗ(t)=w(iₗ), where w(·) is a waveform function. The sensing RX node 1804 may obtain (step 2008, FIG. 20) the value of the quantized TX difference angle, ϕ₁, by estimating the parameters of the received sensing signal and using the mapping received by the sensing RX node 1804 in step 2002. Using the measurements, the sensing RX node 1804 may also estimate an AoA for the sensing signal received from the sensing TX node 1802-l. Eventually, using the information of the quantized TX difference angle of the sensing TX node 1802-l as well as the AoA for the sensing signal received from the sensing TX node 1802-l, the sensing RX node 1804 may apply geometric approaches to obtain (step 2010, FIG. 20) the unknown sensing RX node angular rotation, α_{R}, that is representative of an orientation of the sensing RX node 1804.

As illustrated in FIG. 18, the quantized TX difference angle, ψₗ, when summed with the sensing RX node angular rotation, α_{R}, and the sensing signal angle of arrival, ϕ_{R}, may be understood to form an angle of π radians or 180 degrees, that is, ϕ₁+α_{R}+ϕ_{R}=π. Accordingly, the sensing RX node 1804 may employ the value of the quantized TX difference angle, ψₗ, obtained in step 2008 in combination with the sensing signal angle of arrival, ϕ_{R}, obtained in step 2010, to obtain (step 2012) the sensing RX node angular rotation, α_{R}=π−(ψₗ+ϕ_{R}).

Aspects of the present application relate to details of sensing signal constellation design. To this point, aspects of the present application may be genericized as involving defining a grid on a space of a sensing state of interest and associating a sensing TX node with a location within the defined grid.

In one particular case, position is selected to be the sensing state of interest. For this case, the grid is defined on a network area. A sensing TX node is associated with indices specifying the area in the grid in which the sensing TX node is positioned. In this case, an M by N, two-dimensional grid is defined. However, it has also been shown, hereinbefore, that the same idea may work for grids with other dimensionalities.

After defining the grid on the space of sensing state of interest, mappings may be established between sensing signal parameters and areas within the grid, where the areas are represented by the grid indices. Indexed areas with the grid may be mapped to distinct sets of sensing signal parameters. A sensing signal generated according to a particular set of sensing signal parameters may be transmitted by a sensing TX node responsive to the sensing TX node determining its position as being within an area, in the grid, that is associated with the particular set of sensing signal parameters.

Aspects of the present application, from another perspective, may be considered to be related to establishing a plurality of sets of sensing signal parameters, one set for each of a plurality of areas on the grid. This may be referenced as a “sensing signal constellation.” Generally, the sensing signal constellation may be defined in an analog domain or in a digital domain. Accordingly, aspects of the present application may be considered to have two options.

A first option, among the two options, relates to an analog-based sensing signal constellation design. The first option may be considered to be suitable for low power sensing. Low power sensing may be understood to relate to a case wherein the sensing RX node is to estimate its sensing state while operating in a low power mode. The sensing state estimating may be accomplished using analog processing. The analog processing may also be termed “RF-dominant” processing.

As discussed hereinbefore, a general form of the chirp signal may be expressed, mathematically, as x(t)=e^{j2πft+jnat}^{²}, where the parameter f is referred to as the starting frequency and the parameter a is referred to as the chirp rate. As discussed hereinbefore, the parameters f and α may be used to embed, into a sensing signal, a sensing state of the sensing TX node. Complexity and power consumption at the sensing RX node may be reduced by assuming that the chirp rate, α, is fixed. Accordingly, the only tunable sensing signal parameter is the starting frequency, f.

Using this tunable sensing signal parameter, a mapping, Q, may be defined between grid indices and the starting frequency of the chirp signal. Accordingly, for the area of a given grid identified by indices (i, j), a task of determining an assigned starting frequency, f_{i,j}, may be considered to involve evaluating a relationship expressed as f_{i,j}=Q (i, j). Consequently, responsive to a sensing TX node self-determining its position to be within the area of the grid identified by indices (i, j), the sensing TX node may transmit a chirp signal with starting frequency f_{i,j}.

The mapping, Q, can be in the form of formula or look-up table. An example mapping, Q, in the form of formula, may be expressed as

$$Q ( i , j ) = \frac{[ ( i - 1 ) + N ( j - 1 ) ] B}{Γ MN} ,$$

wherein B denotes bandwidth for the chirp waveform and τ>1 is used to limit a frequency shift to no more than

$$\frac{B}{Γ} .$$

Also, M and N are the grid dimensions, that is, the maxima of index j and index i, respectively. The mapping, Q, may be transmitted (step 706, FIG. 7) to the sensing TX nodes and the sensing RX nodes through control signaling, such as RRC signaling. It follows that a given sensing TX node may determine (e.g., in step 806, FIG. 8) a starting frequency to use based on the mapping received, for example, in step 802 (FIG. 8) and the sensing state determined, for example, in step 804 (FIG. 8). Later, the sensing RX node may estimate the starting frequency of the transmitted chirp signal through the use of low-complexity matched filtering and envelop detection or through the process of de-chirping and beat frequency detection. Upon estimating the starting frequency, the sensing RX node may use the mapping, Q, received, for example, in step 902 (FIG. 9), to determine, for example, in step 908 (FIG. 9), the sensing state of the sensing TX node that transmitted the chirp signal.

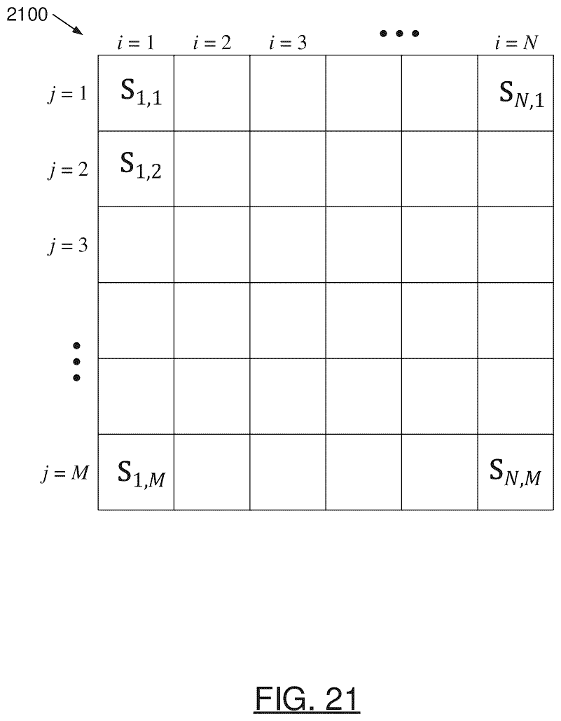

A second option, among the two options, relates to a digital-based sensing signal constellation design. In the second option, a digital sequence may be used to embed, into a sensing signal, a sensing state of the sensing TX node. That is, a distinct digital sequence may be associated with distinct, indexed areas within a defined grid. FIG. 21 illustrates an M by N two-dimensional grid 2100 as an example of a digital-based constellation design. A generic area of the grid 2100, associated with indices (i, j), is associated with a term, S_{i,j}, representative of a digital sequence assigned thereto.

One example of a digital sequence suitable for use in aspects of the present application is the known Zadoff-Chu (ZC) sequence. Distinct ZC sequences can be assigned to distinct areas of the grid 2100. In addition to being distinct, each digital sequence is preferably differentiable at the sensing RX node. The expression S_{ZC} (c, u, L) may be understood to refer to a ZC sequence that has a particular length, L, is based on a particular root, u, and a cyclic shift value, c. In aspects of the present application, the root, u, may be used as a parameter to embed, in a sensing signal, a sensing state of a sensing TX node. A mapping, rᵤ, may be defined to relate a specific pair of grid indices to a specific root, u, to be associated with the area of the grid 2100 represented by the specific pair of grid indices. It follows that, when a ZC sequence with a given length, L, has been assigned to area of the grid 2100 represented by specific pair of grid indices, (i, j), the expression for the ZC sequence may be written as S_{i,j}=S_{ZC} (c, rᵤ(i, j), L).

In aspects of the present application, the cyclic shift, c, may be used as a parameter to embed, in a sensing signal, a sensing state of a sensing TX node. A mapping, rc, may be defined to relate a specific pair of grid indices to a specific cyclic shift, c, to be associated with the area of the grid 2100 represented by the specific pair of grid indices. It follows that, when a ZC sequence with a given length, L, has been assigned to area of the grid 2100 represented by specific pair of grid indices, (i, j), the expression for the ZC sequence may be written as S_{i,j}=S_{ZC} (r_{c} (i, j), u, L). In aspects of the present disclosure, both a cyclic shift, c, and a root, u, may be used as parameters to embed, in a sensing signal, a sensing state of a sensing TX node through a mapping, rc, to relate a specific pair of grid indices to a specific cyclic shift, c, and a mapping, rᵤ, to relate a specific pair of grid indices to a specific root, u, to be associated with the area of the grid 2100 represented by the specific pair of grid indices. It follows that, when a ZC sequence with a given length, L, has been assigned to area of the grid 2100 represented by specific pair of grid indices, (i, j), the expression for the ZC sequence may be written as S_{i,j}=S_{ZC} (r_{c} (i,j), rᵤ(i,j), L).

Another example of a digital sequence suitable for use in aspects of the present application is the known m-sequence. Distinct m-sequences can be assigned to distinct areas of the grid 2100. In addition to being distinct, each digital sequence is preferably differentiable at the sensing RX node. The expression S_{m-seq}(s, L, P) may be understood to refer to an m-sequence that has a seed, s, a length, L, and a characteristic polynomial, P. In aspects of the present application, the seed, s, may be used as a parameter to embed, in a sensing signal, the sensing state of a sensing TX node. A mapping, g, may be defined to relate a specific pair of grid indices to a specific seed, s, to be associated with the area of the grid 2100 represented by the specific pair of grid indices. It follows that, when an m-sequence with a given length, L, and a given characteristic polynomial, P, has been assigned to area of the grid 2100 represented by specific pair of grid indices, (i, j), the expression for the m-sequence may be written as S_{i,j}=S_{m-seq}(g(i,j), L,P).

A further example of a digital sequence suitable for use in aspects of the present application is the known gold sequence. Notably, a gold sequence may be understood to be a result of a bit-by-bit XOR operation being applied to two m-sequences. To generate a gold sequence for each area of the grid 2100, a first characteristic polynomial and a second characteristic polynomial may be selected. A first seed, s₁, for the first m-sequence may be set to 000 . . . 01. The first seed, ϕ₁, may then be used, in combination with the first characteristic polynomial, to generate a first m-sequence with a given length, L. A second seed, s₂, may then be used, in combination with the second characteristic polynomial, to generate the second m-sequence with the given length, L. A bit-by-bit XOR operation may be carried out on the two m-sequences to obtain a gold sequence. A mapping, h, may be defined to relate a specific pair of grid indices to a specific second seed, ϕ₂, to be associated with the area of the grid 2100 represented by the specific pair of grid indices. It follows that, when a gold sequence with the given length, L, and to given characteristic polynomials, P₁, P₂, has been assigned to area of the grid 2100 represented by specific pair of grid indices, (i, j), the expression for the gold sequence may be written as S_{i,j}=S_{gold-seq}(s₁, h(i, j), L, P₁, P₂).

For ZC sequences, m-sequences and gold sequences, orthogonal or semi-orthogonal sequences may be assigned to different grid areas. However, there is no requirement for using orthogonal or semi-orthogonal sequences. It may be shown that relaxing any requirement for orthogonality among sequences, sequence length may be reduced, thereby, reducing resource overhead. Given a particular sequence length, L, it is known that, at most, L orthogonal sequences may be defined. Given the same particular sequence length, L, and relaxing any requirement for orthogonality, it may be shown that more than L sequences may be defined. It follows that, if it is desired that the number of sequences will fill an M×N grid, allowing the sequences to be correlated leads to a possibility of using sequences that have a reduced length relative to the length of sequences that would be used if orthogonality is imposed. Recall that reduced length for the sequences leads to reduced resource overhead. Further notably, correlation among sequences assigned to neighboring grid areas may be shown to be tolerable, since a resultant sensing error (e.g., a resultant positioning error) is not very large in those situations wherein error occurs due to the correlation. It follows that correlation among the sequences assigned to grid areas distant from each other in the grid might be limited or zero.

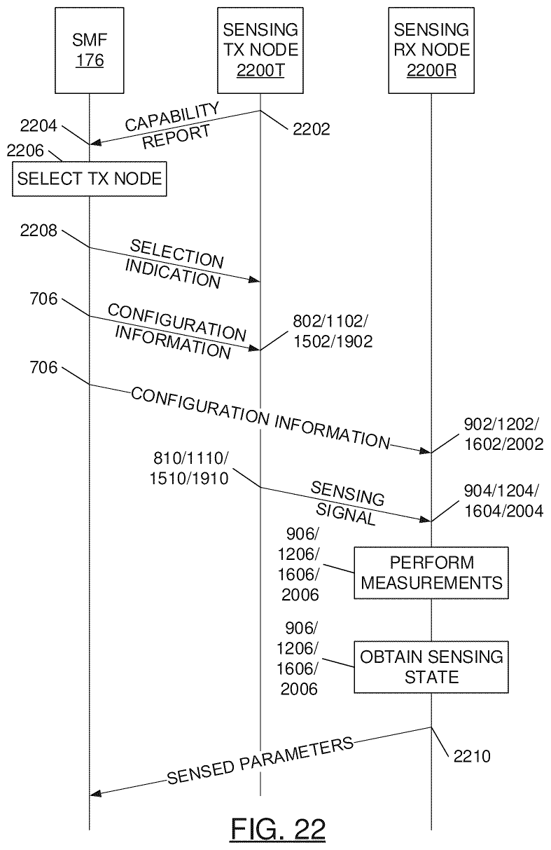

Aspects of the present application relate to signaling exchanges. FIG. 22 illustrates, in a signal flow diagram, interaction between an SMF 176, a sensing TX node 2200T and a sensing RX node 2200R, in accordance with aspects of the present application. Initially, the sensing TX node 2200T transmits (step 2202), to the SMF 176, a capability report. The single sensing TX node 2200T illustrated in FIG. 22 may be considered to be representative of a plurality of sensing TX nodes, as illustrated in FIG. 6. It follows that the SMF 176 receives (step 2204) the capability report transmitted in step 2202 an addition to a plurality of other capability reports transmitted by other sensing TX nodes. On the basis of the capability reports, the SMF 176 may select (step 2206) the sensing TX node 2200T to be a sensing TX node. Up until the point of being selected, the sensing TX node 2200T may simply be existing as a UE, an anchor or other type of network node. Although not shown, the sensing RX node 2200R may, optionally, transmit a capability report to the SMF 176 to, thereby, indicate abilities and availability.

In general, the SMF 176 may select (step 2206) the sensing TX node 2200T based on status, features and capabilities such as position, synchronization status and transmit power capability. It may be the case that there is a preference to have one or multiple sensing TX nodes 2200T in different geographical parts of a network. In such a case, the position of the sensing TX node 2200T may be a factor in the sensing TX node selection (step 2206).

Responsive to the selecting(step 2206), the SMF 176 may transmit (step 2208), to the sensing TX node 2200T, a selection indication, indicating that the sensing TX node 2200T has been selected. The selection indication may be transmitted (step 2208) to the sensing TX node 2200T by control signaling(e.g., RRC signaling or MAC-CE). As discussed hereinbefore in view of FIG. 7, the SMF 176 may transmit (step 706) sensing signal configuration information (e.g., a set of mappings and time-frequency resources) to the sensing TX node 2200T and to the sensing RX node 2200R.

The transmitting(step 2208) of the configuration information may, for one example, be accomplished using RRC signaling. As discussed in view of FIGS. 8, 11, 15 and 19, the sensing TX node 2200T receives (step 802/1102/1502/1902) the sensing signal configuration information. Similarly, as discussed in view of FIGS. 9, 12, 16 and 20, the sensing RX node 2200R also receives (step 902/1202/1602/2002) the sensing signal configuration information.

Next, the sensing TX node 2200T may generate (step 808/1108/1508/1908) a sensing signal based on sensing signal parameters determined (step 806/1106/1506/1906) based on the mappings received (step 802/1102/1502/1902) from the SMF 176 in combination with the sensing TX node 2200T sensing state obtained in step 804/1104/1504/1904.

Subsequently, the sensing TX node 2200T may transmit (step 810/1110/1510/1910) the generated sensing signal.

Upon receiving(step 904/1204/1604/2004) the sensing signal, the sensing RX node 2200R may perform (step 906/1206/1606/2006) measurements on the received sensing signal.

The sensing RX node 2200R may process the measurements to obtain (step 912/1212/1612/2012) an estimate for the sensing state of the sensing RX node 2200R. as discussed hereinbefore, examples of sensing state include: position; velocity; AOA; and orientation. Eventually, the sensing RX node 2200R may, optionally, feedback, to the SMF 176, the obtained sensing state of the sensing RX node 2200R.

It is notable that, unlike known approaches, there is no need for an information exchange between the sensing RX node 2200R and the SMF 176 before the estimation of the sensing state of the sensing RX node 2200R by the sensing RX node 2200R. Conveniently, the removal of any need for an information exchange between the sensing RX node 2200R and the SMF 176 may be shown to reduce service latency and reduce power consumption at the sensing RX node 2200R.

Aspects of the present application relate to solutions for controlling overhead of resources spent on sensing signals, such as reusing a smaller grid to cover an entirety of a space defined for a sensing state. An example is provided hereinafter, wherein position has been selected to be the sensing state. However, it should be clear that the solutions embodied in the example may be used in relation to spaces for other types of sensing state.

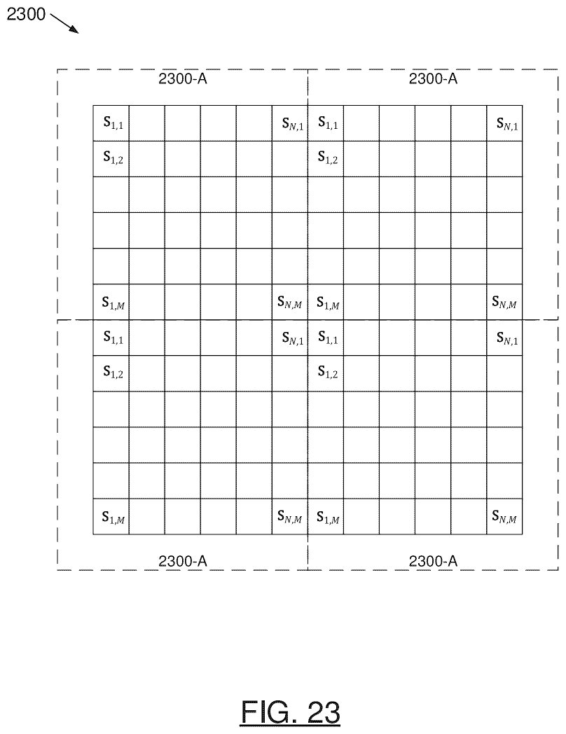

FIG. 23 illustrates an example network area 2300 that has been covered by repeating a smaller, two-dimensional grid 2300-A four times. The example of FIG. 23 may be considered to be representative of a so-called “reuse factor” set to one.

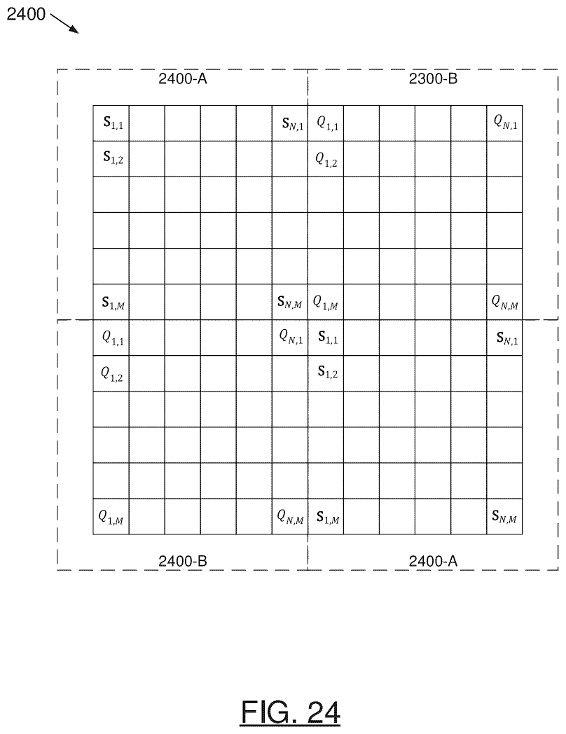

FIG. 24 illustrates another example network area 2300 that has been covered by repeating a first smaller, two-dimensional grid 2400-A twice and by repeating a second smaller, two-dimensional grid 2400-B twice. The example of FIG. 24 may be considered to be representative of a reuse factor set to two. Notably, the reuse factor may be adjusted.

Further notably, the repetition of grids may be shown to lead to some ambiguity. For example, in FIG. 23, the sequence associated with notation S_{1,1} has been assigned to four different grid areas. Upon determining(step 908, FIG. 9), at a sensing RX node, that a received sensing signal has been generated, by a sensing TX node, based on the sequence associated with notation S_{1,1}, the sensing RX node may not obtain clarity regarding the position of the sensing TX node. However, upon obtaining(step 910, FIG. 9) further information, such as an angle of arrival of the sensing signal, ambiguity regarding the position of the sensing TX node may be obviated.

Aspects of the present application relate to an overlaid grid design. The general goal is to enable multiple sensing RX nodes in a network to obtain, from sensing signal parameters estimated on the basis of sensing signal measurements, their own sensing state with low overhead and low latency. Flexibility may be introduced such that the sensing signal parameters that are to be estimated, as well as key performance indicators associated with the sensing RX nodes obtaining their own sensing state, may be different for different sensing RX nodes.

Aspects of the present application relate to defining multiple grids on a sensing state space. Hereinbefore, examples have been presented wherein a two-dimensional grid is defined for position estimation (see FIG. 6), wherein a two-dimensional grid is defined for velocity estimation (see FIG. 10) and wherein a one-dimensional grid is defined for channel subspace estimation (see FIG. 14). Aspects of the present application relate to using more than one grid at the same time. To facilitate the use of more than one grid at the same time, each grid type may be configured with different time/frequency resources.

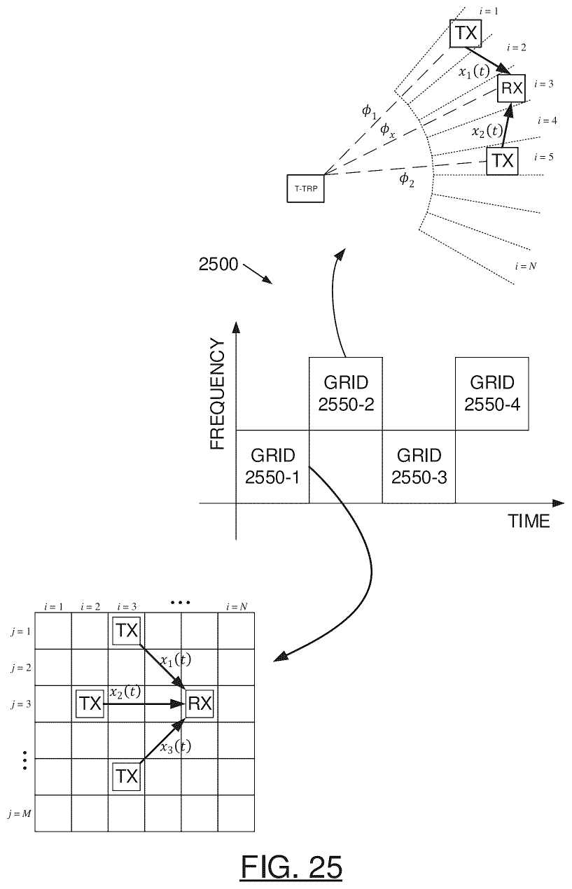

FIG. 25 illustrates an example of the use of more than one grid at the same time, in accordance with aspects of the present application. FIG. 25 illustrates a resource configuration map 2500. The resource configuration map 2500 includes an indication of time/frequency resources for a first grid 2550-1, time/frequency resources for a second grid 2550-2, time/frequency resources for a third grid 2550-3 and time/frequency resources for a fourth grid 2550-4 (collectively or generically 2550). In accordance with aspects of the present application, the first grid 2550-1 may be a grid of a first type. Indeed, FIG. 25 illustrates that the first grid 2550-1 is of the type of the grid of FIG. 6 and that the second grid 2550-2 is of the type of the grid of FIG. 14.

It should be clear that a central authority (e.g., the SMF 176) may be given a task of providing, to a plurality of sensing TX nodes and a plurality of sensing RX nodes, the resource configuration map 2500 along with configuration details for each grid 2550. This providing may be accomplished using RRC signaling.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof.

For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method, comprising:
obtaining, by a sensing signal transmitting node, a sensing state;
determining, by the sensing signal transmitting node and based on the sensing state, a sensing signal parameter;
generating, by the sensing signal transmitting node and based, at least in part, on the sensing signal parameter, a sensing signal; and
transmitting, by the sensing signal transmitting node, the sensing signal.

2. The method of claim 1, wherein the sensing state comprises a position vector for the sensing signal transmitting node.

3. The method of claim 1, wherein the sensing state comprises a velocity vector for the sensing signal transmitting node.

4. The method of claim 1, wherein the sensing state comprises an orientation for the sensing signal transmitting node.

5. The method of claim 1, wherein the sensing state comprises angle information for the sensing signal transmitting node, the angle information comprising an angle of arrival for a signal from a network entity.

6. A method, comprising:
defining a grid on a space including a plurality of sensing states for a first node;
establishing a mapping between an area on the grid and a sensing signal parameter; and
transmitting, to a second node, an indication of the mapping.

7. The method of claim 6, wherein the second node comprises a sensing signal transmitting node, and the indication of the mapping allows the sensing signal transmitting node to generate a sensing signal with the sensing signal parameter based on detecting a particular sensing state for the sensing signal transmitting node in the area of the grid.

8. The method of claim 6, wherein the area on the grid comprises a rectangular area.

9. The method of claim 6, wherein the area on the grid comprises a range of angles of arrival for a signal from a network entity.

10. The method of claim 6, wherein the second node comprises a sensing signal transmitting node, and wherein the plurality of sensing states comprises a plurality of position vectors for the sensing signal transmitting node.

11. An apparatus at a side of a sensing signal transmitting node, comprising:
at least one processor; and
at least one memory storing instructions which when executed by the at least one processor configure the apparatus to perform operations including:
obtaining a sensing state;
determining, based on the sensing state, a sensing signal parameter;
generating, based, at least in part, on the sensing signal parameter, a sensing signal; and
transmitting the sensing signal.

12. The apparatus of claim 11, wherein the sensing state comprises a position vector for the sensing signal transmitting node.

13. The apparatus of claim 11, wherein the sensing state comprises a velocity vector for the sensing signal transmitting node.

14. The apparatus of claim 11, wherein the sensing state comprises an orientation for the sensing signal transmitting node.

15. The apparatus of claim 11, wherein the sensing state comprises angle information for the sensing signal transmitting node, the angle information comprising an angle of arrival for a signal from a network entity.

16. An apparatus, comprising:
at least one processor; and
at least one memory storing instructions which when executed by the at least one processor configure the apparatus to perform operations including:
defining a grid on a space including a plurality of sensing states for a first node;
establishing a mapping between an area on the grid and a sensing signal parameter; and
transmitting, to a second node, an indication of the mapping.

17. The apparatus of claim 16, wherein the second node comprises a sensing signal transmitting node and the indication of the mapping allows the sensing signal transmitting node to generate a sensing signal with the sensing signal parameter based on detecting a particular sensing state for the sensing signal transmitting node in the area of the grid.

18. The apparatus of claim 16, wherein the area on the grid comprises a rectangular area.

19. The apparatus of claim 16, wherein the area on the grid comprises a range of angles of arrival for a signal from a network entity.

20. The apparatus of claim 16, wherein the second node comprises a sensing signal transmitting node, and wherein the plurality of sensing states comprises a plurality of position vectors for the sensing signal transmitting node.
